(19) United States
(12) Patent Application Publication
(10) Pub. No.: US 2008/0127791 A1
(43) Pub. Date: Jun. 5, 2008

(54) Roller sheet material dispenser

(75) Inventors: Giovanni Benedetti, West Kilbride (GB); Jamie Wilson, Linlithgow (GB); Graham Sharp, Renfrew (GB); Stephen Slack, Airdrie (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Benedetti International PLC

(21) Appl. No.: 11/978,303

(22) Filed: Oct. 29, 2007

Related U.S. Application Data
(62) Division of application No. 10/513,766, filed on Nov. 8, 2004, now abandoned.

(30) Foreign Application Priority Data
May 24, 2002 (GB) 0211956.8

(51) Int. Cl. B26D 1/00; B65H 35/06

(52) U.S. Cl. 83/13; 83/649

(57) ABSTRACT

There is disclosed a film dispenser comprising a housing adapted to receive and hold a roll of film and having a dispensing opening through which a layer of film may pass, the dispenser being provided with a movable cutting unit having a blade mounted therein, the dispenser further comprising a cutting channel shaped and positioned to receive said blade. It is preferred that the dispenser has means to maintain tension in the film as it is cut.

### RELATED APPLICATION

This application is a divisional application of U.S. patent application Ser. No. 10/513,766, which is the national stage of PCT/GB03/02299.

### FIELD OF THE INVENTION

The invention relates to a dispenser for dispensing portions of film or sheets of material such as cellophane or cling film, foil, grease proof paper, wrapping paper etc.

### BACKGROUND OF THE INVENTION

Films and other sheet materials are usually manufactured as continuous rolls of material and conveniently may be sold in a suitable dispensing device. Films intended for food purposes, such as plastic cling film, microwave film or freezer film, cellophane, metal (e.g. aluminium) foils or greaseproof paper, are generally available in the form of a continuous roll and short sections of an appropriate length are cut off as required. Films for food purposes are commonly sold packaged within a disposable cardboard box which has been adapted to dispense the film during the lifetime of the roll. Thus the box may be provided with a slot through which the film is fed and toothed blades of metal or plastic or card are positioned adjacent to or along one edge of the slot to allow the desired length of film to be torn off.

However, these boxes are not convenient to use. First, the toothed blades provided are always exposed at the edge of the box. The blades must naturally be sharp enough to tear the film being dispensed and inevitably any user may be cut by the blade whilst removing the portion of film required or in general handling of the box of film. In addition to the painful nature of such a cut, there is a more important hygiene problem which can arise. Thus the cardboard box, if smeared with blood from a cut finger or by traces of foodstuffs etc, cannot easily be wiped clean and since a large roll of catering film may last for several months there is a risk of contamination not only to the film itself, but also to the people who subsequently handle the box and to the food prepared by them after they have handled the box. Second, the rectangular base of cardboard dispensing boxes is easily soaked with water or other fluids. Since the boxes are only formed from cardboard, they become soft permitting moisture to come into contact with the film. If the boxes become very wet, they may even completely collapse which makes any further dispensing of film difficult.

Another disadvantage of the typical cardboard boxes available is that the film is usually difficult to grab, and when grabbed, it is difficult to separate the desired length of material from the roll without tearing the sheet. Furthermore, it is quite usual that whilst being cut, the end of the sheet thus formed folds over and sticks to itself. When the film is thin and formed from a tacky material (such as cling film) this is highly undesirable as the folded film is rendered unusable for sealing and wrapping purposes and unfolding the folded sheet is extremely difficult.

The size of these conventional dispensing boxes will of course vary depending on the size of the roll contained therein. Roll size is in turn determined by the frequency of use of the film and the cost per metre of film acceptable to the buyer, and thus there is a distinct variation between the products sold for household use and those of the catering industry. Although the problems arising from such dispensing boxes are more acute in the catering industry (because of the greater frequency of use and increased likelihood of contamination problems), similar inconveniences occur at domestic level.

### SUMMARY OF THE INVENTION

It is therefore one of the objects of the invention to provide a film dispenser which overcomes at least some of the drawbacks noted above. It is a further object of the invention to provide a dispenser which is disposable, safe and easy to use while being of low cost to manufacture.

It should be understood that the term “film” encompasses all material provided in thin sheet form, especially kitchen cling film, greaseproof paper, aluminium foil and wrapping paper.

According to the present invention there is provided a film dispenser comprising a housing adapted to receive and hold a roll of film and having a dispensing opening through which a layer of film may pass, the dispenser being provided with a movable cutting unit having a blade mounted therein, the dispenser further comprising a cutting channel shaped and positioned to receive said blade.

Preferably the cutting channel is defined by elongated elements, like flanges, projecting from the surface of the housing, which lie substantially parallel to the dispensing opening.

To provide a neat cut it is preferable that the portion of film provided over the cutting channel is put under tension. Therefore the dispenser advantageously comprises film tensioning means to maintain the tension in a layer of film positioned over the cutting channel.

Preferably the film tensioning means comprises a gripping surface which is advantageously located on one side of the cutting channel. The presence of the gripping surface is not essential for the operation of the dispenser. It has been found that in their absence the dispenser may still sever the film if the user manually applies tension to the film, but the results are less consistent. Where no gripping surfaces are provided it is highly advantageous to use an extremely sharp blade as this minimises the pressure required to sever the film.

A gripping surface is predominantly relevant for a cling film dispenser for two main reasons:
Cling film tends to stick to a variety of surfaces, whereas foil or parchment, for example, do not.
Cling film is generally more elastic and trickier to cut cleanly than other films and therefore benefits most from being under tension.

For a gripping surface to be effective it is essential that it grips the film to some degree. Defining standard criteria for a suitable surface has not proved possible. Rather, suitable surfaces must be selected by virtue of their ability to sufficiently grip the film of interest. Suitable materials for use as a gripping surface are described later. In addition a test is described which allows the selection of materials which are suitable for use in a gripping surface.

Preferably the film tensioning means comprises a pair of gripping surfaces, one on each side of the cutting channel. It is particularly preferred that the superior surface of the elongated elements provide the gripping surfaces.

Preferably the gripping surface has a shear force in relation to PVC cling film of greater than 100 Nm⁻¹.

The gripping surface is advantageously formed of a soft flexible PVC. Particularly preferred is modified nytril rubber PVC. A particularly suitable material is the modified nytril rubber PVC sold by the company API S.p.A of Via D. Alighieri, 27-36065, Mussolente, Italy under the Trade Mark Apilon 33.

Preferably the movable cutting unit comprises a blade holding channel, the blade holding channel being defined by longitudinal flanges with the blade mounted therebetween.

Preferably the interior sides of the longitudinal flanges are adapted to co-operate with the exterior surfaces of the elongated elements. This co-operation can take the form of a simple guiding interaction which helps align the film on the gripping surface for efficient cutting; in this interaction there is no real need for physical contact between the longitudinal flanges and the elongated members. Alternatively it can take the form of a physical interaction where the flanges contact the elongated elements trapping the film therebetween.

Preferably the movable cutting unit is provided on a lid portion which is connected via a hinge to the dispenser, the axis of the hinge lying substantially parallel to the cutting channel.

Preferably the dispenser is further provided with film presentation means. The presence of a film presenting means is advantageous for two reasons:
It may act to prevent the end of the roll of film from getting reattached to the roll, whereby it is difficult to retrieve.
It presents the film so that it can easily be grasped by the user.

Preferably the film presentation means comprises a member located between the cutting channel and the dispensing opening, the member being deflectable from a film presenting position, where it stands proud from the dispenser and the roll of film, to a retracted position where it lies substantially within the housing.

It is further preferred that the housing and the film presenting means are each made from one piece of plastics material. Suitably the housing and the film presenting means are extruded. Extrusion is preferred due to cost effectiveness, simplicity and scalability of the process.

It is further preferred that the blade is metal saw-toothed blade. A metal blade is preferred as it is generally sharper than a plastics blade. A plastics blade would also be suitable in some instances.

According to a further embodiment of the present invention there is provided a method of severing a piece of film from a layer of film comprising the steps of:
providing a layer of film over a cutting channel;
providing tensioning means to maintain the tension in the layer of film over the cutting channel; and
severing said layer of film with a blade.

Preferably said tensioning means comprise a pair of gripping surface positioned one on each side of the cutting channel.

The film dispenser of the present invention is of course particularly suited for the dispensing of film for food purposes (especially in the catering industry), but may of course also be used where any roll of film or other sheet material needs to be dispensed in short sections. Examples where the dispenser of the present invention may be especially suitable include hospitals (for the dispension of film or other dressing materials, paper or the like) and schools (for the dispension of wrapping paper).

The invention will be further described by reference to particularly preferred embodiments of the invention described in the accompanying drawings.

### BRIEF DESCRIPTION OF THE DRAWINGS

FIG. 1 is a rear isometric view of a dispenser according to an embodiment of the invention with the lid in an opened position.

FIG. 2 is a front isometric view of the dispenser with the lid in an opened position.

FIGS. 3a to 3d all show a cross-sectional view of the dispenser from a plane perpendicular to the axis of the roll of film. FIG. 3a shows the lid in an open position. FIG. 3b shows the dispenser with the lid in a partially closed position with the blade contacting the layer of film. FIG. 3c shows the dispenser with the lid slightly more closed and the blade exerting pressure against the layer of film. FIG. 3d shows the lid in a fully closed position with the layer of film severed by the blade.

FIG. 4 is a side view the dispenser without end caps or blade and no roll of film present.

FIGS. 5a and 5b are isometric views of an end cap from the external and internal sides respectively.

FIG. 6a shows the blade used in the dispenser and FIG. 6b shows an enlarged view of the blade.

FIG. 7 is a sequence of schematic representations of a test apparatus for determining the shear force of a test sample, and illustrating the steps involved in carrying out the test.

### DETAILED DISCUSSION OF THE DRAWINGS

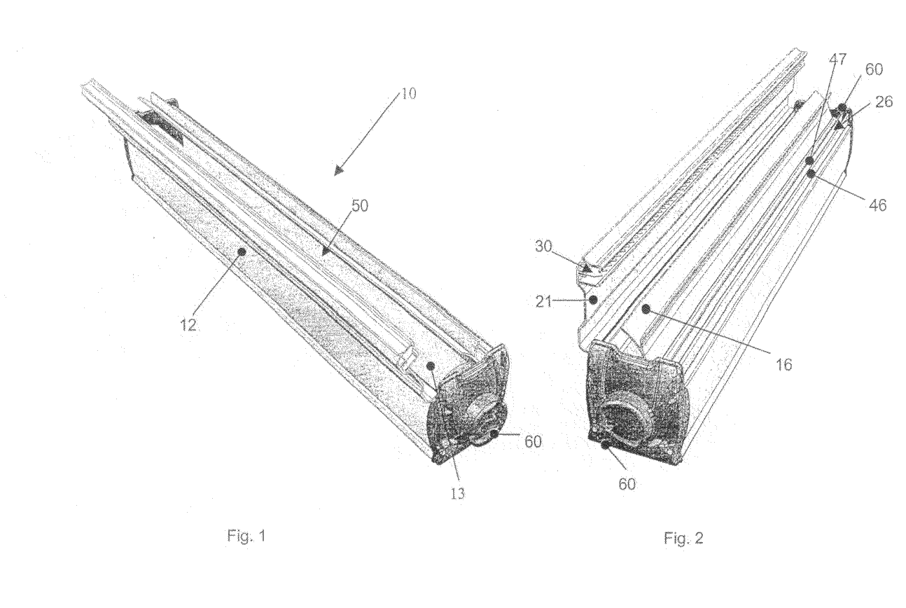

Referring to the accompanying drawings, FIGS. 1 and 2 show a dispenser 10 made according to a preferred embodiment of the invention. The dispenser 10 is provided with a housing 12. The housing 12 is advantageously sized and shaped to accommodate a tubular roll of film 14.

The housing 12 is of generally square cross-section, but it should be understood that a different shape of housing, for example a housing having a circular or oval cross-section, could also be used. Dispensers designed to contain retail-size film rolls are smaller than the ones designed for the catering industry. For those dispensers a rectangular or square cross-section is preferred as being more convenient to apply labels or the like on the dispenser sides.

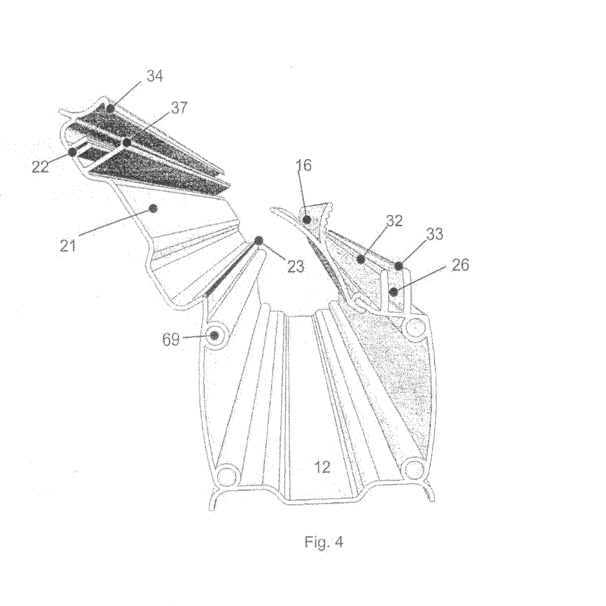

As best shown in FIG. 4 the housing 12 (including the lid portion 21) in this embodiment is a one-piece unit. The film presentation means 16 is made separately and attached to the housing by way of an interlocking notch and grove mechanism. The housing 12 and lid portion 21, and the film presentation means 16 are preferably made out of plastics material, for example PVC or other similar plastics material which is safe for food contact. These components can be moulded, or preferably extruded, into the desired shape. The simplicity of manufacture of such components substantially reduces the costs of manufacture of the dispenser 10 as the number of distinct parts is reduced to a minimum, and both the material and the manufacturing process are inexpensive.

The housing 12 comprises a lid portion 21 which is pivotally connected to the remaining part of the housing 12 via a hinge portion 23. This hinged portion 23 can be made of flexible PVC (e.g. the family of modified nytril rubber PVC compounds known as Apilon 33) which can be co-extruded with the more rigid PVC which forms the major part of the housing 12.

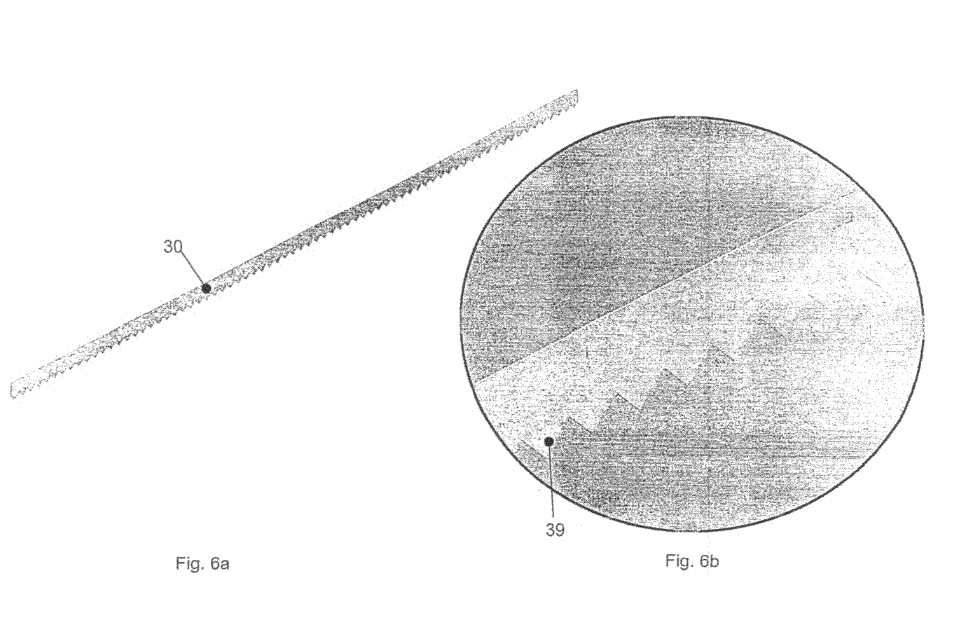

As shown on FIG. 2, a longitudinal blade 30 is mounted on the lid portion 21 as part of a movable cutting unit. The blade 30 comprises a series of generally triangular teeth 39 in a saw-tooth arrangement, which are best shown in FIGS. 6a and 6b. The blade 30 is made of metal, preferably stainless steel. However, plastics materials could also be used, though plastic blades are generally less sharp. The tip of the triangular teeth 39 are tapered to ensure that the material is fully severed after the initial perforation is made. The blade 30 is sized and shaped to fit within a corresponding longitudinal slot 22 provided in the movable cutting unit provided on the lid portion 21. The blade is secured within the longitudinal slot 22 by means of the interlocking of small protuberances in the walls of the slot 22 with notches in the blade 30.

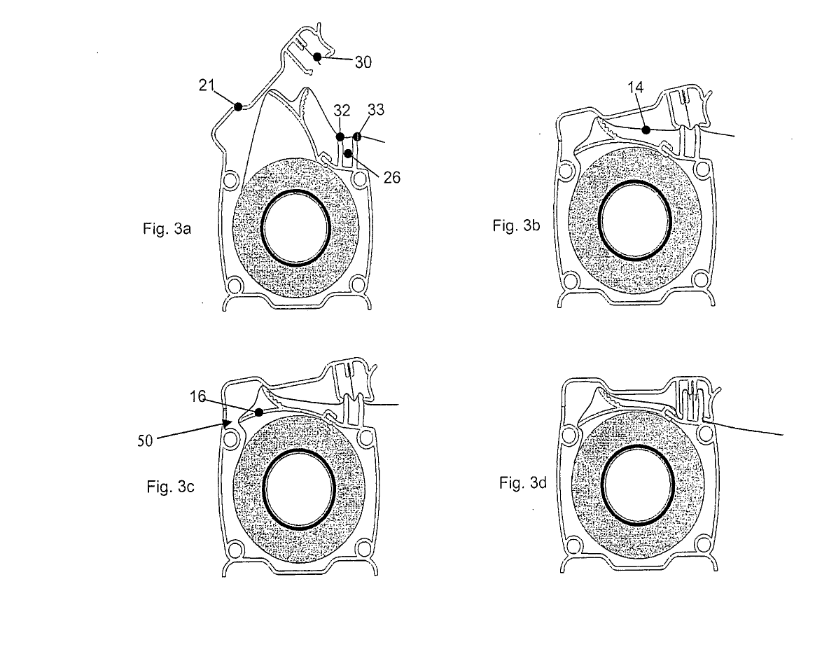

When in the open position, the lid portion 21, and the blade 30 attached thereto, are at an angle to the top part of the housing 20 to which the lid portion 21 is hinged and thus defines a dispensing opening 50 shown in FIGS. 1 and 3. The dispensing opening 50 is wide enough so that at least one layer of the film 14 to be dispensed can be passed through, and is long enough so that the full width of film 14 can also be passed through without wrinkling or folding.

The lid portion 21 can pivot around the hinge portion 23 and adopt a “closed” position, best shown in FIG. 3d, where the blade 30 is inserted into a cutting channel 26, which is provided on the outer surface of the housing 12 and defined by the raised elements 46 and 47.

Dispenser 10 is provided with tensioning means which act to ensure the portion of film 14 over the cutting channel 26 is held under tension as it is cut.

In this embodiment of the invention the tensioning means comprises film gripping surfaces 32,33 positioned proximal to the cutting site where they can contact the layer of film to be cut. As shown in FIG. 4, gripping surfaces 32,33 are advantageously positioned on both sides of the cutting groove 26. The film is thus held by the gripping surfaces 32,33 on each sides of the cutting site. In this example the gripping surfaces are the superior surfaces of the elongated elements 46,47 which define the cutting channel 26, and this arrangement has proven to be particularly efficient. The gripping surfaces 32,33 are advantageously provided along the entire length of the edge of the cutting channel 26.

The tensioning means of the dispenser 10 may also comprise further elements besides the gripping surfaces 32,33. The elongated elements 46,47 and the longitudinal flanges 34,37 co-operate to form a further tensioning means besides the gripping surface 32,33. The elongated elements 46,47 and longitudinal flanges 34,37 are provided in a jaw-like arrangement. The longitudinal flanges 34,37 contact the film and pull it down the sides of the elongated elements 34,37. This action acts to position the film firmly onto the gripping elements 32,33. In this embodiment the longitudinal flanges 34,37 act mainly as guide elements.

In an alternative embodiment the internal side of the longitudinal flanges 34,37 are shaped and sized such that they will press against the external sides of the elongated elements 46,47 when the lid is closed. The longitudinal flanges 34,37 are slightly resilient which allows them to deflect around the elongated elements 46,47, whilst maintaining pressure on the film. Thus the film 14 which passes over the cutting channel 26 will be trapped between the longitudinal flanges 34,37 and the elongated elements 46,47 when the lid portion 21 is closed and thus held tightly. Contact between the longitudinal flanges and the elongated elements is not, however, essential for the operation of the dispenser.

Thus the longitudinal flanges and elongated elements, in co-operation with the gripping surfaces 32,33 guide, seize, hold and tension the film over the cutting channel 26 during cutting. In addition, these features cause the severed portion of film 14 to remain positioned along the edge of the cutting channel 26 after cutting, and before the user removes the severed sheet from the dispenser 10 thus avoiding inadvertent folding or wrinkling and the like of the severed sheet.

In use the tensioning means of the present dispenser operate as follows:

A length of film 14 is pulled by the user over the cutting channel 26 and placed in contact with the gripping surfaces 32,33. As best shown on FIGS. 3a to 3d, when the lid portion 21 is moved to the closed position by the user, the longitudinal flanges 34,37 contact the film 18 lying over the cutting channel 26 and drag it along the external faces of the elongated elements 46,47 thus providing additional tension. This movement also presses the film firmly against the gripping surface 32,33.

The dispenser also has a film presentation means which is located between the cutting channel 26 and the dispensing opening 50. It advantageously comprises a member 16 in the form of a Y-shaped piece of resilient plastics material. It is attached to the housing 12 at along the edge of the dispensing opening by the base of the Y. Particularly when cling film is used it is often difficult to separate the end of the roll of film 13 from the bulk of the roll. To prevent this problem, the film presentation means 16 is provided in order to retain the edge of the film 14 connected to the roll 13 separate from the roll and rendering it easily grippable.

The member 16 is resilient and can flex from a film presenting position to a recessed position (as shown in FIGS. 3a to 3d). When the lid 21 is closed it deflects the member 16 from the film presenting to the recessed position. When the lid 21 is re-opened, the member 16 springs back to the film presenting position. As the member 16 springs back to the film presenting position it lifts the end of the film 14 from the cutting channel 26 and holds it in a position in which it is easily accessible for the user to grasp. The resilient nature of the member 16 also makes it possible to flex it out of the way if access to the roll of film 13 is required, for example if the end of the film requires retrieval.

The operation of the dispenser to obtain a severed sheet of film will now be described. FIG. 3a shows the lid portion 21, provided with the blade 30 at its extremity, which lies in its normally opened position. When the user pulls the desired length of film 14, a portion of the film lies over the cutting channel 26. The user then applies pressure on the external surface of the lid portion 21, moving the lid portion 21 and consequently the movable cutting unit towards the cutting channel 26. FIG. 3b shows that, as the movement of the blade 30 toward the cutting channel 26 continues, the longitudinal flanges 34,37 engage the film and drag it down the external sides of the elongated elements 46,47. As a result, the portion of film 14 to be cut is held in position and as the blade 30 contacts the film 14. Continued downward movement of the lid portion 21 engages the blade 30 with the film 14, which is now held under tension. As the pressure on the film increases the tips of the blade pierce the layer of film 14 (FIG. 3c). As the movement is continued the blade 30 continues cut until the layer of film is completely severed as shown in FIG. 3d. The cut edges of the film 14 are retained in position until the lid portion 21 is raised. The lid portion 21 can then be returned to its normal (opened) position and the sheet of film 14 which has been severed is freed and available for immediate use.

It is particularly advantageous that when the lid portion 21 is opened, the edge of the separated sheet of film will be held in position by the gripping surface 33. The other severed end initially remains attached to griping surface 32, but it is lifted clear by the film presentation means. The member 16 of the film presentation means holds the film proud from the rest of the dispenser 10 enabling the user to easily grasp the film for repeat use.

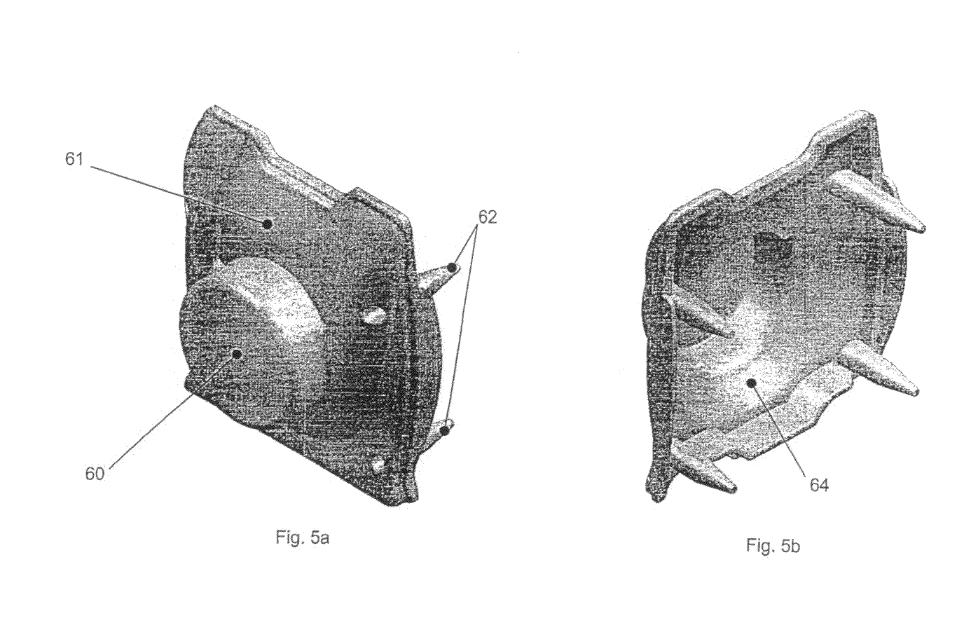

FIGS. 5a and 5b shows two end caps 60 which are provided at the two lateral extremities of the housing 12. These, end caps 60 can be attached to the housing 12 through prongs 62 which engage socket connection points 69 provided within the housing 20. Advantageously the prongs 62 will break if the end caps 60 are removed so as to prevent re-use of the dispenser 10. A small area 61 of the end caps 60 can be thinned down so as to be transparent or translucent to allow the user to see the amount of film remaining on the roll of film 13. Also, the interior profile of the cap 64 advantageously guides the core of the roll of film 13 into its normal centre of rotation in order to facilitate easy assembly of the dispenser and render it suitable for mass production.

When the end caps 60 are provided on the housing 20 the dispenser 10 thus formed is substantially water-tight and sealed from external contaminants. Thus, when the dispenser 10 is positioned on a kitchen working surface (which are frequently wet) the roll 13 will be less susceptible to being soaked and/or accidentally contaminated.

An optional feature (not shown in the drawings) is the incorporation of an additional hinged section to allow easier access to the roll of film 13. In operation it may be difficult to retrieve the end of the film 14 from the roll of film 13. For this reason an additional hinge may be provided between the hinge 23 of lid portion 21 and the remaining part of the dispenser housing 20. This hinged top section would usually be held closed through a longitudinal catch on the housing 20, coaxial with the hinge 23, the catch engaging with corresponding small prongs provided on the end cap 60. If wider access to the roll of film 13 (for example if the end of the film 14 has fallen inside the housing 12 and is difficult to grab) this catch can be detached from the prongs and the additional part of the housing can be opened. Once the end of the film has been retrieved the section can then be re-closed. In this position, access to the roll of film 12 would be restricted, thus reducing the risk of contamination.

Alternatively the lid portion 21 can simply be made wide enough allow easy access to the roll of film 13. This alternative is preferred when the dispenser 10 is sized to receive small rolls of film and is intended for domestic use.

As mentioned previously, the dispenser is suitable for dispensing a number of different materials including films, foils and parchments. The exact specifications of the dispenser for different materials will likely alter, but the general principles will remain the same. In a dispenser for aluminium foil, for example it is found that efficient cutting is achieved without gripping surfaces 32,33 and it is preferable if the longitudinal flanges 34,37 and the elongated elements 46,47 do not contact when the dispenser is closed. This is because foil is relatively easy to cut and is prone to tearing. In addition, when the described dispenser is used for foil, the foil tends to become folded around the film presentation means. This ensures it does not slip off the film presentation means and is consistently presented in an easily accessible manner for the user.

When cling film is used, it is highly desirable that a gripping surface be provided on the dispenser forming a tensioning means.

Test to Evaluate the Suitability of a Material for use as a Gripping Surface.

The presence of a gripping surface at the edge of the cutting channel is particularly advantageous in this invention. The choice of the material to apply on the cutting channel is determined by the nature of the film to be cut.

Generally a suitable material for gripping cling film or the like must have suitable material surface properties. It is believed that such surfaces facilitate the formation of a “vacuum effect” by virtue of the exclusion of air from between the film and the surface. This vacuum effect then resists movement or removal of the film. The chemical nature of the surface may also play an important role.

It is proposed that the suitability of a material as a gripping surface is determined by three main factors:
1) The chemical composition of the film and the gripping surface.
In particular, the degree of cross-linked polymers in each may have an effect on how well the surfaces will adhere.
2) The roughness of the gripping surface.
Cling film adheres less readily to a rough surface as there are more air pockets between the film and the surface and there is therefore less chance of forming a vacuum or of chemical adherence between the materials. The surface finish of a material is determined mainly by the manufacturing process although certain materials may never be suitable due to porosity or other inability to form a smooth surface.
3) The flexibility of the material forming the gripping surface. On a microscopic level a more flexible material smoothes out more easily and hence promotes the chemical or vacuum effects that adhere the surfaces together.

As there are numerous chemical and mechanical effects involved in the adherence of cling film to a surface, it is extremely difficult to accurately assess from the properties of a material alone whether or not it will grip a certain type of film. This makes selection of materials for the gripping surface difficult.

In order to select a suitable material for the gripping surface a simple trial and error process can be adopted. A number of suitable surfaces could be tried until a suitable material is found. The number of materials tested could be limited by the knowledge that the material should be capable of forming a non-porous surface.

However it would be expensive and time consuming to manufacture a sample dispenser from all proposed materials and it is therefore beneficial if a simple test can be performed to assess the suitability of a material. To this end a suitable test apparatus is described below.

A measurement that can be taken to compare the adherent properties of cling film against a gripping surface is the “shear force” required to free the film from the gripping surface. The shear force is clearly dependent on all three factors mentioned earlier. It must be noted, however, that to allow comparison between gripping surfaces exhibiting differing sizes, this shear force must be quantified relative to the length of the test sample over which the film is adhered.

The shear force of a test sample of a material can be obtained using the test described below. Preferably the area and the dimensions of the different test samples to which the cling film grips should be constant. Generally a larger area of test sample will be used than would actually be found in the gripping surface of the dispenser. The larger surface area helps to minimise the level of error in the results of the test. It is, however, useful if the geometry of the surface of the test sample is similar to the geometry of the gripping surface of the dispenser.

It will be understood that for a material to be suitable for the gripping surface the shear force has to be of sufficient magnitude to ensure that the pressure of the blade against the film causes the film to yield and sever, i.e. the film does not slip as it is cut. The exact arrangement of blade type, gripping material properties, geometry etc is not important so long as the shear pressure of the material is sufficient to facilitate severing.

It is not possible to define a precise threshold limit of shear force below which a material will not be suitable, and above which it will; there are simply too many variables involved. These variables include:

Geometry of the gripping surface,

other tensioning means in the dispenser, e.g. jaw arrangement, and

type of film to be severed.

However, it will be possible to assess whether a material can be dismissed immediately as not suitable, has potential, or is a definite candidate for use as a gripping surface.

By using the methodology described below, the shear force of virtually any material can be determined to investigate whether it is suitable for use as a gripping surface.

In summary, the shear force is obtained by adhering a layer of film over a sample of the material to be tested. Then a force is applied to the film. The force is steadily increased until the film is detached from the sample. The force recorded before the film is detached from the sample is the shear force. This value is divided by the length of the test sample to obtain the shear force relative per unit length.

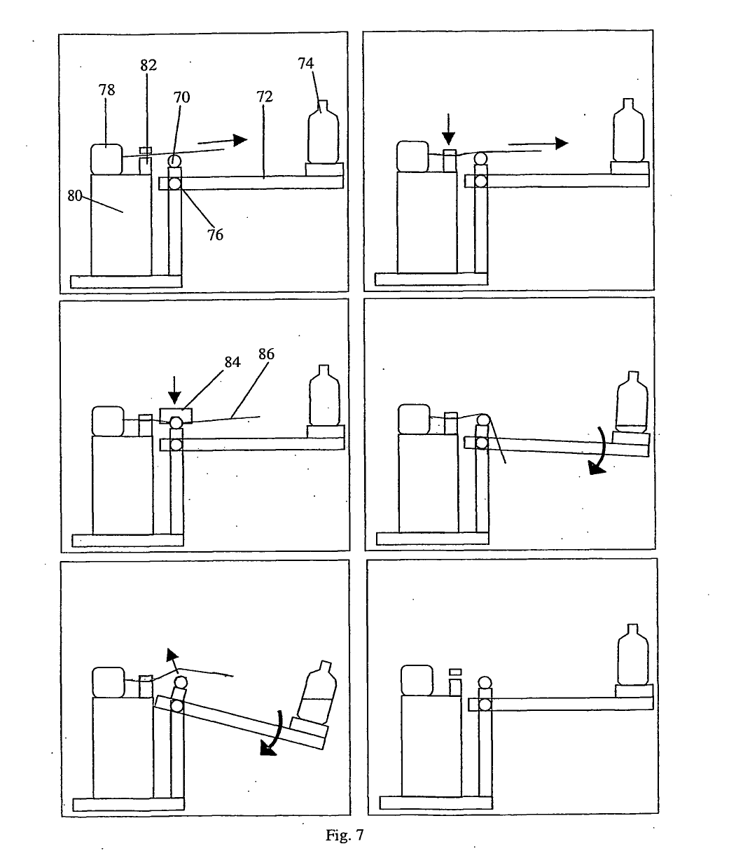

FIG. 7 shows a suitable test apparatus. The test sample is preferably shaped as a cylindrical rod 70 and is mounted on a hinged test platform 72. The hinged test platform 72 provides a clamping means (not shown) for maintaining the test rod 70 in a position whereby it cannot move through either rotational or cartesian translations. Clearly there are a number of suitable clamping means available in the art, for example a fixed collar which can be tightened to hold the rod 70 securely. The hinged test platform 72 is able to rotate about a hinge 76. The hinged test platform 72 also has a bottle 74 fixed thereto at the end distal to the hinge. It is important to note that the forces on the hinged test platform 72 are balanced when the bottle 74 is empty; thus the hinged test platform works like a balance and only when the bottle 74 is filled is a torque applied to the hinge 76 and movement occurs.

The test apparatus further comprises a film holding platform 80. The film holding platform 80 has a film clamp 82 which is designed to hold the test sample of film tightly and prevent slipping. The film clamp 82 may comprise two bars of steel having flat parallel faces which, when clamping the film, are urged firmly together sandwiching the film therebetween. For example the two bars may be bolted together or clamped using a G-clamp. The film clamp is securely attached to the film holding platform.

A reserve or dispenser of film 78 may also be provided for in the test apparatus, conveniently located on the film holding platform 80. This is not essential and is not immediately involved in the operation of the test apparatus and is merely provided for convenience.

A film press 84 is used to adhere the film onto the test sample. As shown in FIG. 7, it is advantageously a block containing a profile complimentary to that of the top surface of the test sample. The film press 84 is of known weight and engages the test rod 70 through a vertical motion. It applies a known force (weight) and thus pressure onto the film 74 draped over the test rod 70. The known force is supplied by the weight of the film press 84 or, if insufficient, known weights can be added on top of the film press 82. This adheres the film 86 to the surface of the test rod 70 in a way approximately analogous to the pressure applied to the film as the dispenser closes. It is thought that the amount of pressure imparted by the film press 82 is not critical to the results of the test so long as it is sufficient to press the film 86 into close contact with the test rod 70. Once adherence has been achieved, applying a greater pressure would not significantly increase the level of adhesion.

A sample is tested according to the following method, described with reference to FIG. 7

A sample of film 86 is drawn from the dispenser 78 and passed between the two bars of the film clamp 82. The bars are clamped together to hold the film tightly across its entire width. The film is draped over the test rod 70 with as little slack as possible and the film press 84 brought into contact with the film.

Once the sample of film has been clamped by the film clamp 82, and adherence of the film 86 to the test rod 70 has been achieved, the bottle 74 is gradually filled with water. The slower and more constant the water is added the better as this allows a more accurate determination of the exact end-point volume of water when slippage occurs, and also surges of water would cause unmeasurable forces not related to the volume of water in the container, thus lessening accuracy.

When the film 86 slips from the test rod 70 the water flow is stopped. This can either be achieved manually stooping the flow (eg. shutting a valve), though this method is open to human error. Alternatively slippage could cause the opening of bottle to move away from the water source thus preventing further water from entering the bottle.

The final volume of water in the bottle is measured and the shear force and/or shear pressure calculated. In the present apparatus the shear force is calculated by calculating the torque imparted at the hinge 76 by the test platform 72 and from this deriving the force applied at the surface of the test rod 70. As the hinged test platform were balanced before the addition of the water the torque on the hinge 76 will be dependent on the weight of the water in the bottle 74 and the distance of the bottle 74 from the hinge 76.

A test of this nature was carried out for a number of materials in association with commercially available PVC cling film, and the results are presented in Table 1.

In the test apparatus as used to obtain these results the critical dimensions were as follows:

Diameter of Test Rod: 9 mm

Distance from hinge to centre of mass of bottle: 850 mm

Distance from hinge to surface of test rod: 95 mm

The samples tested were of the following materials:

Apilon 33: a modified nytril rubber PVC

Atochem FEJ 611: PVC based extrudable thermoplastic polymer.

C40/55 Grey Dugdale: PVC based extrudable thermoplastic polymer

Apigo 8348NL: SEBS based extrudable thermoplastic polymer

Alcryn 2250 UT: PVC based extrudable thermoplastic polymer

Laporte: SEBS based extrudable thermoplastic polymer

Glass: tubular glass from fluorescent light tube.

Table 1—Results of test and calculations to derive Shear Force in N/m.

TABLE 1

| | | | Atochem FEJ | C40/55 Grey | | Alcryn | | |
|---|---|---|---|---|---|---|---|---|
| Test | | Aplion 33 | 611 | Dugdale | Apigo 8348 NL | 2250 UT | Laporte Vol | Glass |
| Number | Material | Vol (ml) | Vol (ml) | Vol (ml) | Vol (ml) | Vol (ml) | (ml) | Vol (ml) |
| 1 | | 415.00 | 130.00 | 0.00 | 115.00 | 20.00 | 130.00 | 635.00 |
| 2 | | 460.00 | 130.00 | 0.00 | 135.00 | 0.00 | 125.00 | 635.00 |
| 3 | | 445.00 | 130.00 | 0.00 | 275.00 | 0.00 | 152.00 | 635.00 |
| 4 | | 440.00 | 150.00 | 0.00 | 140.00 | 0.00 | 250.00 | 635.00 |
| 5 | | 520.00 | 140.00 | 0.00 | 175.00 | 0.00 | 160.00 | 635.00 |
| 6 | | 465.00 | 120.00 | 0.00 | 225.00 | 0.00 | 240.00 | 635.00 |
| 7 | | 390.00 | 160.00 | 0.00 | 195.00 | 0.00 | 315.00 | 635.00 |
| 8 | | 575.00 | 135.00 | 0.00 | 155.00 | 0.00 | 340.00 | 635.00 |
| 9 | | 460.00 | 100.00 | 0.00 | 185.00 | 0.00 | 350.00 | 635.00 |
| 10 | | 575.00 | 122.00 | 0.00 | 215.00 | 10.00 | 400.00 | 635.00 |
| | Average | 474.50 | 131.70 | 0.00 | 181.50 | 3.00 | 246.20 | 635.00 |
| | Medium | 460.00 | 130.00 | 0.00 | 180.00 | 0.00 | 245.00 | 635.00 |
| | SD | 62.82 | 16.53 | 0.00 | 48.31 | 6.75 | 101.38 | 0.00 |

| | | Atochem FEJ | C40/55 Grey | | | | |
|---|---|---|---|---|---|---|---|
| | Aplion 33 | 611 | Dugdale | Apigo 8348 NL | Alcryn 2250 UT | Laporte | Glass |
| | Vol (ml) | Vol (ml) | Vol (ml) | Vol (ml) | Vol (ml) | Vol (ml) | Vol (ml) |
| Force Calculations | | | | | | | |
| Mass Ave (Kg) | 0.47 | 0.13 | 0.00 | 0.18 | 0.00 | 0.25 | 0.64 |
| Mass Med (Kg) | 0.46 | 0.13 | 0.00 | 0.18 | 0.00 | 0.25 | 0.64 |
| Weight Ave (N) | 4.65 | 1.29 | 0.00 | 1.78 | 0.03 | 2.42 | 6.23 |
| Weight Med (N) | 4.51 | 1.28 | 0.00 | 1.77 | 0.00 | 2.40 | 6.23 |
| SD (Kg) | 0.06 | 0.02 | 0.00 | 0.05 | 0.01 | 0.10 | 0.00 |
| SD (N) | 0.62 | 0.16 | 0.00 | 0.47 | 0.07 | 0.99 | 0.00 |
| Torque at Pivot | | | | | | | |
| Torque at Pivot AVE. | 3.96 | 1.10 | 0.00 | 1.51 | 0.03 | 2.05 | 5.29 |
| (Nm) | | | | | | | |
| Torque at Pivot MED | 3.84 | 1.08 | 0.00 | 1.50 | 0.00 | 2.04 | 5.29 |
| (Nm) | | | | | | | |
| Torque at Pivot SD | 0.52 | 0.14 | 0.00 | 0.40 | 0.06 | 0.85 | 0.00 |
| (Nm) | | | | | | | |
| Shear Release Force | | | | | | | |
| Force at Shear AVE. | 41.65 | 11.56 | 0.00 | 15.93 | 0.26 | 21.61 | 55.74 |
| (N) | | | | | | | |
| Force at Shear MED | 40.38 | 11.41 | 0.00 | 15.80 | 0.00 | 21.50 | 55.74 |
| (N) | | | | | | | |
| Force at Shear SD (N) | 5.51 | 1.45 | 0.00 | 4.24 | 0.59 | 8.90 | 0.00 |
| Shear Release Force | | | | | | | |
| per Metre | | | | | | | |
| Force at Shear AVE. | 138.83 | 38.53 | 0.00 | 53.10 | 0.88 | 72.03 | 185.79 |
| (N/m) | | | | | | | |
| Force at Shear med | 134.59 | 38.04 | 0.00 | 52.66 | 0.00 | 71.68 | 185.79 |
| (N/m) | | | | | | | |
| Force at Shear SD. | 18.38 | 4.84 | 0.00 | 14.13 | 1.97 | 29.66 | 0.00 |
| (N/m) | | | | | | | |
| Summary | | | | | | | |
| Force at Shear MED. | 134.59 | 38.04 | 0.00 | 52.66 | 0.00 | 71.68 | 185.79 |
| (N/m) | | | | | | | |
| +/− | 30.15 | 7.93 | 0.00 | 23.18 | 3.24 | 48.65 | 0.00 |
| 95^{th} % ile. Max. | 164.73 | 45.97 | 0.00 | 75.84 | 3.24 | 120.33 | 185.79 |
| 5^{th} % ile. Min. | 104.44 | 30.10 | 0.00 | 29.48 | 0.00 | 23.03 | 185.79 |

As can be seen there is a great difference between the shear force values of each of the samples. Glass and Apilon 33 both exhibit high shear force values. In fact glass exhibits such a high shear force that the layer of film actually failed before it slipped from the test rod. Other samples did not adhere to the film at all well, e.g. Alcryn 2250 UT and C40/55 Grey Dugdale.

To test the validity of this result a test sample of the dispenser was made up with Apilon 33 and Alcryn 2250 UT as the gripping surfaces. The polymers were co-extruded with the rigid PVC polymer which forms the bulk of the dispenser. As was expected the dispenser containing Apilon 33 severed the film consistently, whereas the dispenser using Alcryn 2250 UT was far less effective, with the cutting process being less consistent and effective with incomplete severing occurring. This demonstrates that the proposed test is a valid means of assessing the suitability of a material for use as the gripping surface.

If a dispenser were required to dispense another type of film, e.g. polyethylene (PE) cling film rather than PVC cling film, the test could be repeated for a number of different test materials to select suitable candidates for incorporation into the dispenser. Indeed the same test was carried out using polyethylene film and a number of test materials and Laporte™ (a styrene-ethylene-butadiene-styrene thermoplastic elastomer) was found to be suitable for use as a gripping surface for polyethylene cling film. This is significant as it is likely that PE will largely replace PVC as the material of choice for cling film production (due to improved safety of PE).

Some general factors have been identified which can be used to speculate on the desired properties of a material for use as a gripping surface. These include:
Slightly pliable or flexible materials have been found to work better than rigid materials. A hardness rating of 40-60 Shore A has been found to be generally suitable.
The surface should be non-porous, though a glossy finish is not required.
PVC cling film tends to adhere to PVC based materials well, it may be speculated that the same would apply to PE or other film materials.

It will be noted that, no matter how well a material grips the film of interest, it will not be suitable for use as a gripping surface if it cannot be incorporated into the dispenser. This might happen for example if the material will not co-extrude with the material which makes up the bulk of the dispenser.

It is also important that the conditions used in the manufacture of the test sample generally reflect the conditions that will be used in the dispenser. This is because the processing of the material can alter its shear force. In general, however, the alteration is not very significant.

1. A film dispenser comprising a housing adapted to receive and hold a roll of film and having a dispensing opening through which a layer of film may pass, the dispenser being provided with a movable cutting unit having a blade mounted therein, the dispenser further comprising a cutting channel shaped and positioned to receive said blade, said cutting channel being defined by elongated elements projecting from the surface of the housing, which lie substantially parallel to the dispensing opening and said dispenser further comprising film tensioning means to maintain the tension in a layer of film positioned over the cutting channel, said film tensioning means comprising a pair of gripping surface located on each side of the cutting channel, wherein the superior surface of the elongated elements provide the gripping surfaces, and wherein the movable cutting unit comprises a blade holding channel, the blade holding channel being defined by longitudinal flanges with the blade mounted therebetween, the interior sides of the longitudinal flanges comprising protuberances projecting internally which are adapted to co-operate with the exterior surfaces of the elongated elements such that they will press against the external sides of the elongated flanges.

2. (canceled)

3. (canceled)

4. (canceled)

5. (canceled)

6. (canceled)

7. A dispenser as claimed in claim 1 wherein the gripping surface has a shear force in relation to PVC cling film of greater than 100 Nm−1.

8. A dispenser as claimed in claim 1 wherein each gripping surface is formed from a modified nytril rubber PVC.

9. (canceled)

10. (canceled)

11. A dispenser as claimed in claim 1 wherein the movable cutting unit is provided on a lid portion which is connected via a hinge to the dispenser, the axis of the hinge lying substantially parallel to the cutting channel.

12. A dispenser as claimed in claim 1 wherein the dispenser is further provided with film presentation means.

13. A dispenser as claimed in claim 12 wherein the film presentation means comprises a member located between the cutting channel and the dispensing opening, said member being deflectable from a film presenting position, where it stands proud from the dispenser and the roll of film, to a retracted position where it lies substantially within the housing.

14. A dispenser as claimed in claim 1 wherein the housing and the film presenting means are each made from one piece of plastics material.

15. A dispenser as claimed in claim 14 wherein the housing and the film presenting means are extruded.

16. A dispenser as claimed in claim 1 wherein the blade is metal saw-toothed blade.

17. A method of severing a piece of film from a layer of film comprising the steps of:
providing a film dispenser comprising a housing adapted to receive and hold a roll of film and having a dispensing opening through which a layer of film may pass, the dispenser being provided with a movable cutting unit having a blade mounted therein, the dispenser further comprising a cutting channel shaped and positioned to receive said blade, said cutting channel being defined by elongated elements projecting from the surface of the housing, which lie substantially parallel to the dispensing opening and said dispenser further comprising film tensioning means to maintain the tension in a layer of film positioned over the cutting channel, said film tensioning means comprising a pair of gripping surface located on each side of the cutting channel, wherein the superior surface of the elongated elements provide the gripping surfaces, and wherein the movable cutting unit comprises a blade holding channel, the blade holding channel being defined by longitudinal flanges with the blade mounted therebetween, the interior sides of the longitudinal flanges comprising protuberances protecting internally which are adapted to co-operate with the exterior surfaces of the elongated elements such that they will press against the external sides of the elongated flanges;
providing a layer of film over the cutting channel; and
severing said layer of film with the blade.

18. (canceled)
